(19) United States
(12) Patent Application Publication
(10) Pub. No.: US 2020/0195789 A1
(43) Pub. Date: Jun. 18, 2020

(54) IMAGE PROCESSING APPARATUS AND IMAGE PROCESSING METHOD

(71) Applicant: TOSHIBA TEC KABUSHIKI KAISHA, Tokyo (JP)

(72) Inventors: Kazunobu Takahashi, Mishima Shizuoka (JP); Yoji Matsuda, Mishima Shizuoka (JP); Hiroshi Yamaguchi, Numazu Shizuoka (JP); Makoto Hibino, Kannami Tagata (JP)

(21) Appl. No.: 16/223,216

(22) Filed: Dec. 18, 2018

(51) Int. Cl. H04N 1/00; H04N 1/21

(52) U.S. Cl. CPC H04N 1/00084; H04N 1/00037; H04N 1/00244; H04N 1/00278; H04N 1/21

(57) ABSTRACT

According to one embodiment, an image processing apparatus includes a damaged file determiner, a response unit, and a file restoration unit. The damaged file determiner determines whether or not a file used in the image processing apparatus is damaged. The response unit requests another device to provide a recovery file to be used to restore the damaged file and obtain the recovery file from another image processing apparatus, when it is determined that the file is damaged. The file restoration unit restores the damaged file by using the recovery file.

### FIELD

Embodiments described herein relate generally to an image processing apparatus and an image processing method.

### BACKGROUND

In information devices, such as a computer and a multifunctional peripheral (MFP) of the related art, various methods are used as measures against data corruption. For example, countermeasures against power loss caused by an uninterruptible power supply (UPS), a method of restoring data stored in a hard disk drive (HDD) by a configuration of redundant arrays of independent disks (RAID), and the like are used. When data corruption occurs, damaged data needs to be restored. However, a lot of manual work and high costs are needed to restore the damaged data.

### DESCRIPTION OF THE DRAWINGS

FIG. 1 is an external view illustrating an example of an overall configuration of an image processing apparatus according to a first embodiment;

FIG. 2 is a schematic system configuration diagram illustrating an image processing system according to the first embodiment;

FIG. 3 is a block diagram illustrating a function of the image processing apparatus according to the first embodiment;

FIG. 4 is a diagram illustrating concrete examples of data stored in an address information storage unit;

FIG. 5 is a diagram illustrating concrete examples of data stored in a file information storage unit;

FIG. 6 is a sequence diagram illustrating a flow of a file restoration performed by the image processing system according to the first embodiment;

FIG. 7 is a sequence diagram illustrating a flow of a file restoration performed by the image processing system according to the first embodiment;

FIG. 8 is a schematic system configuration diagram illustrating an image processing system according to a second embodiment;

FIG. 9 is a block diagram illustrating a function of an image processing apparatus according to the second embodiment;

FIG. 10 is a block diagram illustrating a function of a server according to the second embodiment;

FIG. 11 is a sequence diagram illustrating a flow of file restoration performed by the image processing system according to the second embodiment; and

FIG. 12 is a sequence diagram illustrating a flow of file restoration performed by the image processing system according to the second embodiment.

### DETAILED DESCRIPTION

In general, according to one embodiment, an image processing apparatus includes a damaged file determiner, a response unit, and a file restoration unit. The damaged file determiner determines whether or not a file used in the image processing apparatus is damaged. When it is determined that the file is damaged, the response unit requests another device to provide a recovery file to be used to restore the damaged file, and obtains the recovery file from another image processing apparatus storing the recovery file. The file restoration unit restores the damaged file by using the recovery file.

Hereinafter, an image processing apparatus and an image processing method according to an embodiment will be described with reference to the drawings.

### First Embodiment

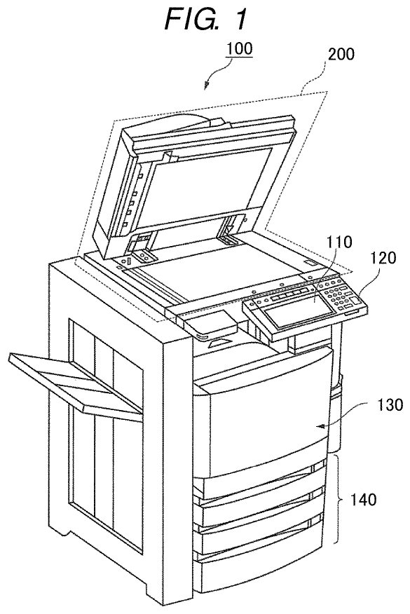

FIG. 1 is an external view illustrating an example of an overall configuration of an image processing apparatus 100 according to a first embodiment. The image processing apparatus 100 is, for example, an image forming apparatus such as a multifunction peripheral. The image processing apparatus 100 includes a display 110, a control panel 120, a printer 130, a sheet accommodation unit 140, and an image reader 200. The printer 130 of the image processing apparatus 100 may be an apparatus which fixes a toner image or an ink jet type apparatus.

The image processing apparatus 100 reads an image appearing on sheet, generates digital data, and generates an image file. The sheet is, for example, an original document, paper on which characters, images, and the like are inscribed, or the like. The sheet is not limited as long as the sheet can be read by the image processing apparatus 100.

The display 110 is an image display device such as a liquid crystal display or an organic electroluminescence (EL) display. The display 110 displays various information regarding the image processing apparatus 100.

The control panel 120 includes a plurality of buttons. The control panel 120 receives a user's manipulation. The control panel 120 outputs a signal corresponding to the user's manipulation to a controller of the image processing apparatus 100. The display 110 and the control panel 120 may be configured as a touch panel together.

The printer 130 forms an image on the sheet based on image information generated by the image reader 200 or image information received via a communication path. The printer 130 forms an image, for example, by the following process. An image former of the printer 130 forms an electrostatic latent image on a photoconductive drum based on the image information. The image former of the printer 130 forms a visible image by attaching a developer to the electrostatic latent image. A concrete example of the developer is toner. A transfer unit of the printer 130 transfers the visible image onto the sheet. A fuser of the printer 130 fixes the visible image on the sheet by heating and pressurizing the sheet. The sheet on which the image is formed may be either sheet accommodated in the sheet accommodation unit 140 or sheet moved by hand.

The sheet accommodating unit 140 accommodates sheet used to form an image by the printer 130.

The image reader 200 reads image information of an object to be read as light and shade. The image reader 200 records the read image information. The recorded image information may be transmitted to another information processing device via a network. An image may be formed on the sheet by the printer 130 based on the recorded image information.

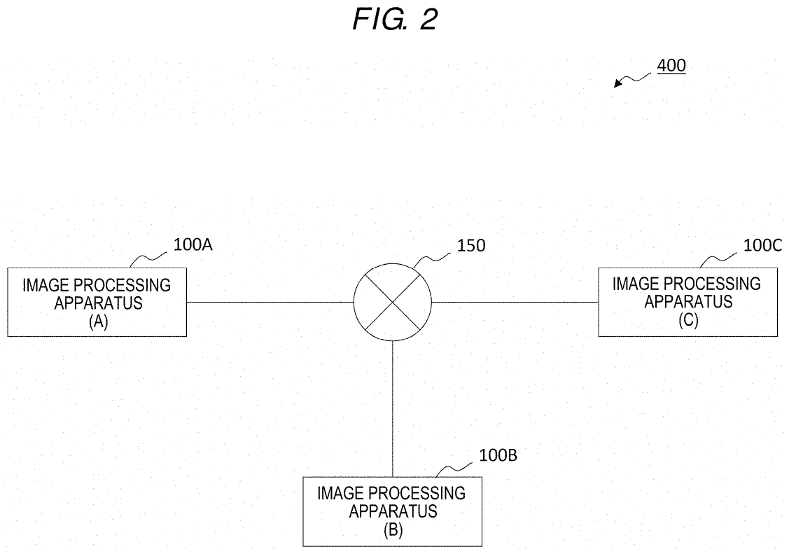

FIG. 2 is a schematic system configuration diagram illustrating the image processing system 400 according to the first embodiment. The image processing system 400 includes a plurality of image processing apparatuses 100 (for example, 100A, 100B, and 100C). The image processing system 400 is configured by connecting the plurality of image processing apparatuses 100 to one another via a network 150. The network 150 is configured using, for example, a local area network (LAN). Alternatively, the network 150 may be configured using a network such as wide area network (WAN) or the Internet according to a connection form. In an example of FIG. 2, three image processing apparatuses 100 are used in the image processing system 400. However, the number of image processing apparatuses 100 used in the image processing system 400 is not limited to three.

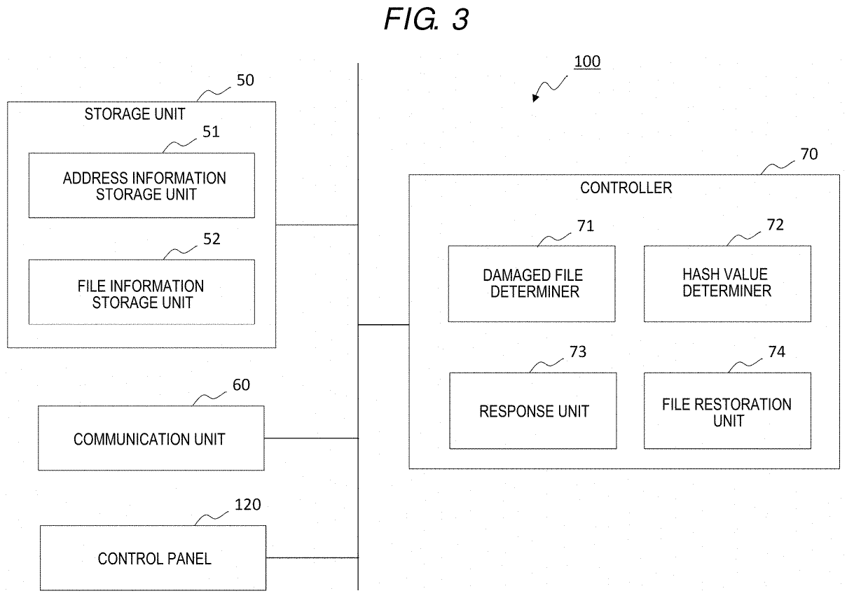

FIG. 3 is a block diagram illustrating a function of the image processing apparatus 100 according to the first embodiment. The image processing apparatus 100 includes a storage unit 50, a communication unit 60, a controller 70, and a control panel 120.

The storage unit 50 is configured using a storage device such as a magnetic hard disk device or a semiconductor storage device. The storage unit 50 functions as an address information storage unit 51 and a file information storage unit 52.

The address information storage unit 51 stores in advance storing device addresses to be mapped to each other. A file name represents the name of each file stored in each image processing apparatus 100. The storing device addresses include an address of the image processing apparatus 100 storing a file to be used for recovery (hereinafter referred to as a “recovery file”). The recovery file is, for example, a file including data of a file to be restored when the file was normal.

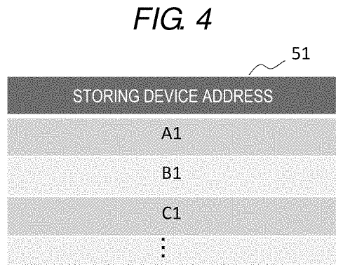

FIG. 4 illustrates concrete examples of data stored in the address information storage unit 51. The address information storage unit 51 stores, for example, an address information table as illustrated in FIG. 4. The address information table includes each value of storing device addresses. The storing device addresses include the address of another image processing apparatus storing a recovery file corresponding to a file indicated by a file name of the same record. Alternatively, the storing device addresses may indicate the addresses of every image processing apparatuses storing recovery file or indicate the addresses of some of the image processing apparatuses.

The file information storage unit 52 stores in advance a file name, a path name, and a hash value of each file such that they are mapped to one another. The file path indicates a path of a storage region in which each file is stored. The hash value of each file is a hash value obtained based on data of each file.

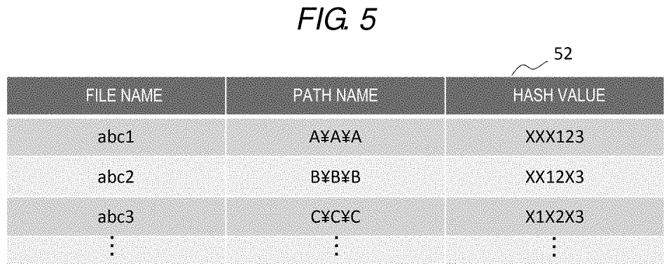

FIG. 5 illustrates concrete examples of data stored in the file information storage unit 52. The file information storage unit 52 stores, for example, a file information table as illustrated in FIG. 5. The file information table includes values of a file name, a path name, and a hash value. The hash value is a hash value of a file stored in a storage region indicated by each path name.

The communication unit 60 is a communication interface. The communication unit 60 establishes data communication with another image processing apparatus 100 via the network 150.

The controller 70 is configured using a processor such as a central processing unit (CPU). When the processor executes a program, the controller 70 functions as a damaged file determiner 71, a hash value determiner 72, a response unit 73, and a file restoration unit 74.

The damaged file determiner 71 determines whether or not there is a damaged file. A file to be determined as to whether it is a damaged file may be, for example, a specific file such as a system file required to operate the image processing apparatus 100. Alternatively, a range of a target file may be changed according to a checking condition. If a damaged file exists, the damaged file determiner 71 determines another image processing apparatus 100 storing a recovery file corresponding to the damaged file.

The damaged file determiner 71 determines whether there is a damaged file by performing, for example, integrity check. The integrity check is a technique for determining the integrity of a file by using an error detection technique such as a checksum or a hash value. The integrity of the file indicates that data in a normal state is not changed. For example, when part of data of a current file is different from the data in the normal state, it is determined that there is no integrity. When such a determination is made, a value, for example, a hash value or the like to be used for the determination is generated and stored in advance based on the data in the normal state.

The hash value determiner 72 determines whether or not a file before being damaged of a damaged file in another image processing apparatus 100 (hereinafter referred to as the “normal file”) and a file stored by the apparatus having the hash value determiner 72 (the image processing apparatus 100) are the same by using a hash value of the file. Any type of hash function may be used by the hash value determiner 72. For example, the hash value determiner 72 may use any one among MD5, SHA-1, SHA-2, and SHA-3.

The response unit 73 controls transmission and reception of data between another image processing apparatus 100 and the apparatus including the response unit 73 (the image processing apparatus 100).

The file restoration unit 74 restores the damaged file. For example, the file restoration unit 74 deletes the damaged file. Thereafter, the file restoring unit 74 records the recovery file, which is obtained from another image processing apparatus 100, in the same path as the deleted damaged file.

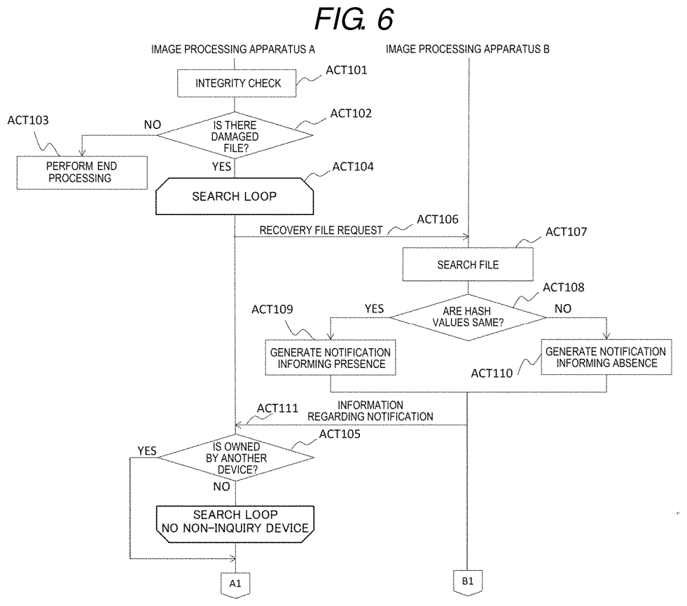

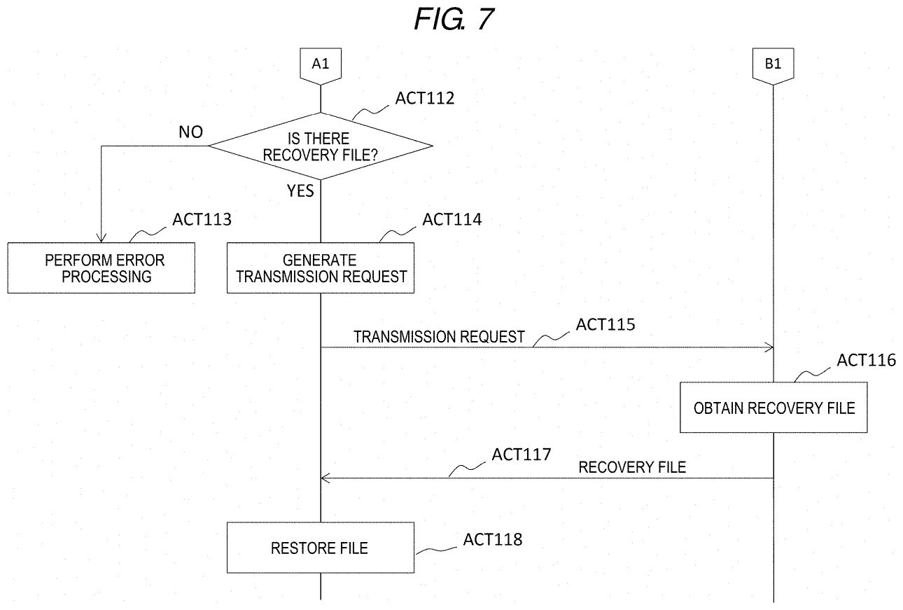

FIGS. 6 and 7 are sequence diagrams illustrating a flow of file restoration performed by the image processing system 400, according to the first embodiment. In the sequence diagrams illustrated in FIGS. 6 and 7, an example of a process performed by two image processing apparatuses (image processing apparatuses A and B) is sequentially illustrated. The damaged file determiner 71 of the image processing apparatus A determines integrity of a file of the image processing apparatus A (ACT 101). Whether or not there is a damaged file in the image processing apparatus A is determined based on a result of determining the integrity of the file. When there is no damaged file (ACT 102—NO), the file restoration is ended (ACT 103).

On the other hand, when there is a damaged file (ACT 102—YES), no-inquiry search loop is performed (ACT 104). The non-inquiry search loop is performed until a notification requesting the recovery file is sent to all other image processing apparatuses 100. The damaged file determiner 71 transmits to other image processing apparatuses 100 a notification inquiring about whether they store a recovery file (ACT 105). When neither of the image processing apparatuses 100 store the recovery file (ACT 105—NO), preprocessing of the non-inquiry search loop (ACT 104) is performed.

When another image processing apparatus has the recovery file (ACT 104—YES), the non-inquiry search loop is stopped and ACT 112 which will be described below is performed. The predetermined information includes, for example, a hash value obtained when the damaged file was normal, a file name, a path name, and a device address of the image processing apparatus 100 storing the recovery file. The hash value, the file name, and the path name may be obtained by reading data from the file information storage unit 52. The device address of the image processing apparatus 100 storing the recovery file may be obtained by reading data from the address information storage unit 51.

The response unit 73 generates a request for the recovery file based on the predetermined information. The request for the recovery file is information indicating a request to check the presence of the recovery file. The request for the recovery file includes the hash value, the file name, and the path name. The response unit 73 transmits the generated request for the recovery file to another image processing apparatus (the image processing apparatus B) indicated by the device address (ACT 106).

The response unit 73 of the image processing apparatus B receives the request for the recovery file. The response unit 73 searches for a file with the same name as the file name included in the received request for the recovery file (ACT 107). The hash value determiner 72 calculates a hash value of the searched file. Next, the hash value determiner 72 determines whether or not the calculated hash value and the hash value included in the request for the recovery file are the same (ACT 108).

When the hash values are the same (ACT 108—YES), the response unit 73 generates a notification informing the presence of the recovery file (ACT 109). Thereafter, the response unit 73 transmits the notification informing the presence of the recovery file to the image processing apparatus A which transmitted the request for the recovery file (ACT 111).

When the hash values are different (ACT 108—NO), the response unit 73 generates a notification informing the absence of the recovery file (ACT 110). Then, the response unit 73 transmits the notification informing the absence of the recovery file to the image processing apparatus A which transmitted the request for the recovery file (ACT 111).

The image processing apparatus A determines whether or not there is the recovery file based on the notification received from the image processing apparatus B (ACT 112). When the notification informing the absence of the recovery file is received (ACT 112—NO), the response unit 73 of the image processing apparatus A performs error processing (ACT 113). When the notification informing the presence of the recovery file is received (ACT 112—YES), the response unit 73 generates a transmission request (ACT 114). The transmission request is information indicating a request to transmit the recovery file. The transmission request includes, for example, a file name and a path name of the recovery file. Then, the response unit 73 transmits the transmission request to the image processing apparatus B which transmitted the notification informing the presence of the recovery file (ACT 115).

Upon receiving the transmission request, the response unit 73 of the image processing apparatus B obtains the recovery file corresponding to the file name and the path name included in the received transmission request (ACT 116). The response unit 73 transmits the obtained recovery file to the image processing apparatus A which transmitted the transmission request (ACT 117).

The file restoration unit 74 of the image processing apparatus A restores the damaged file by using the received recovery file (ACT 118).

According to the image processing system 400 of the first embodiment configured as described above, the damaged file is restored without human intervention. Thus, even if a damaged file is generated in the image processing apparatus 100, it is possible to reduce efforts or costs required to restore the damaged file.

Furthermore, according to the image processing system 400 of the first embodiment, the recovery file may be obtained from another image processing apparatus 100 connected to the same image processing system 400. Generally, files of the same version are highly likely to be used in devices connected to the same image processing system 400. Accordingly, there is a high possibility that a file of the same version as the damaged file before the damaged file was damaged will be searched for.

### Modification Example

When a serious problem such as a booting failure due to damage to a kernel file occurs, the image processing apparatus 100 may stop the processing. Furthermore, when an error occurs, the image processing apparatus 100 may notify the occurrence of the error to a service center by using a communication unit such as a mail or a facsimile function.

The request for the recovery file may include a path name. That is, whether there is the recovery file may be determined by determining whether path names are the same, as well as the performance of ACT 109 (the determination of the hash value).

In ACT 109 (the determination of the hash value), the hash value determiner 72 may read the hash value from the file information storage unit 52 rather than calculating the hash value. However, a more recent hash value may be obtained when the hash value determiner 72 calculates the hash value rather than reading the hash value. Thus, even if a file corresponding to the recovery file is damaged in the image processing apparatus B, the damage can be identified. Accordingly, it is possible to prevent the damaged file from being erroneously transmitted as the recovery file to the image processing apparatus A.

The hash value determiner 72 of the image processing apparatus A may calculate the hash value of the recovery file. The hash value determiner 72 of the image processing apparatus A may calculate the hash value, for example, between ACT 118 of receiving the recovery file and ACT 119 of restoring the file. In this case, even when a rare case of the recovery file being damaged in a communication path occurs, the damage may be identified. Thus, it is possible to prevent recovery from being erroneously performed using the damaged file. When the hash value is calculated, the determination of the hash value (ACT 109) performed by the image processing apparatus B may be omitted.

### Second Embodiment

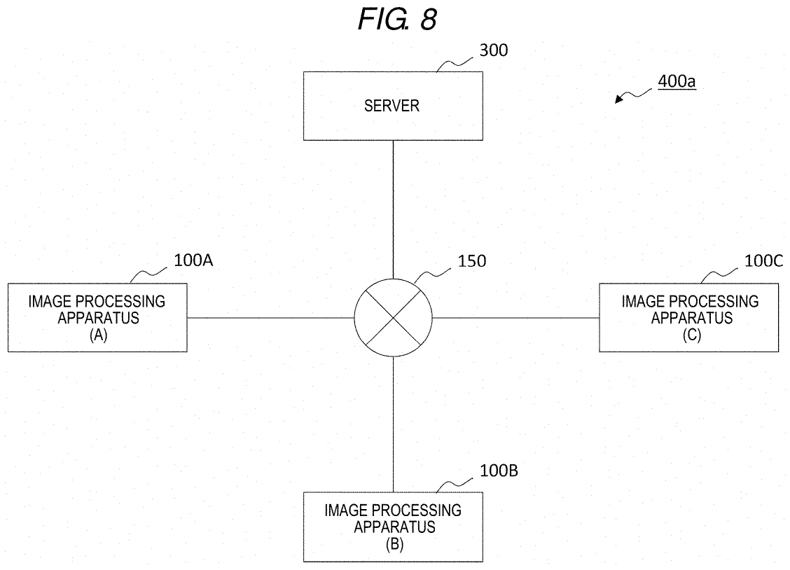

FIG. 8 is a schematic system configuration view illustrating an image processing system 400a according to a second embodiment. The image processing system 400a according to the second embodiment includes a plurality of image processing apparatuses 100 (for example, 100A, 100B, and 100C) and a server 300. The image processing system 400a is configured by connecting the plurality of image processing apparatuses 100 and the server 300 to one another via a network 150. The network 150 is configured using, for example, a local area network (LAN). Alternatively, the network 150 is configured using a network such as a wide area network (WAN) or the Internet according to a connection form. In an example of FIG. 8, three image processing apparatuses 100 and one server 300 are used in the image processing system 400a. However, the number of the image processing apparatuses 100 and the number of the server 300 used in the image processing system 400a is not limited thereto.

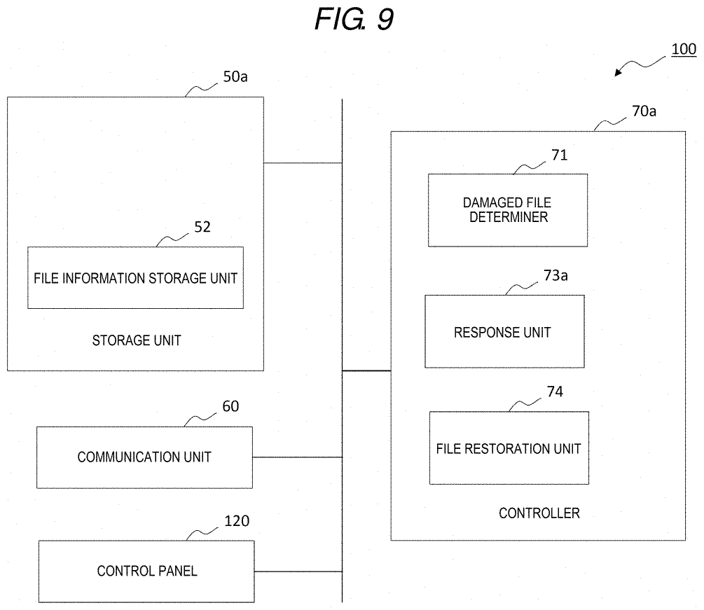

FIG. 9 is a block diagram illustrating a function of the image processing apparatus 100 according to the second embodiment. The image processing apparatus 100 includes a storage unit 50a, a communication unit 60, a controller 70a, and a control panel 120. The communication unit 60 and the control panel 120 have the same configurations as those of the first embodiment. Accordingly, description is omitted here.

The storage unit 50a is configured using a storage device such as a magnetic hard disk device or a semiconductor storage device. The storage unit 50a functions as a file information storage unit 52. The file information storage unit 52 has the same configuration as that of the first embodiment. Accordingly, description of the file information storage unit 52 is omitted here.

The controller 70a is configured using a processor such as a CPU. When the processor executes a program, the controller 70a functions as a damaged file determiner 71, a response unit 73a, and a file restoration unit 74. The damaged file determiner 71 and the file restoration unit 74 have the same configurations as those of the first embodiment. Accordingly, description is omitted here. A response unit 73a controls transmission and reception of data between the server 300 and the apparatus including the response unit 73a (the image processing apparatus 100).

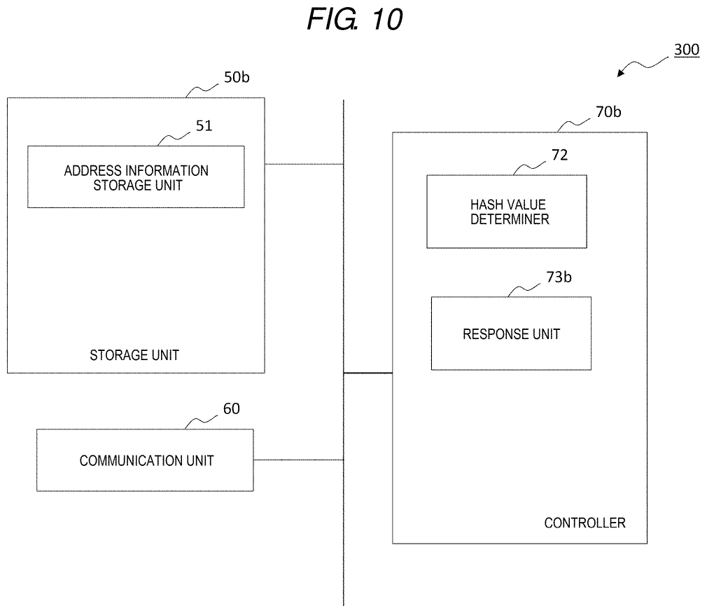

FIG. 10 is a block diagram illustrating a function of the server 300 according to the second embodiment. The server 300 includes a storage unit 50b, a communication unit 60, and a controller 70b. The communication unit 60 has the same configuration as that of the first embodiment. Accordingly, description is omitted here.

The storage unit 50b is configured using a storage device such as a magnetic hard disk device or a semiconductor storage device. The storage unit 50b functions as an address information storage unit 51. The address information storage unit 51 has the same configuration as that of the first embodiment. Accordingly, description is omitted here.

The controller 70b is configured using a processor such as a CPU. When the processor executes a program, the controller 70b functions as a hash value determiner 72 and a response unit 73b. The hash value determiner 72 has the same configuration as that of the first embodiment. Accordingly, description is omitted here. The response unit 73b controls transmission and reception of data between the image processing apparatus 100 and the apparatus including the response unit 73b (the server 300).

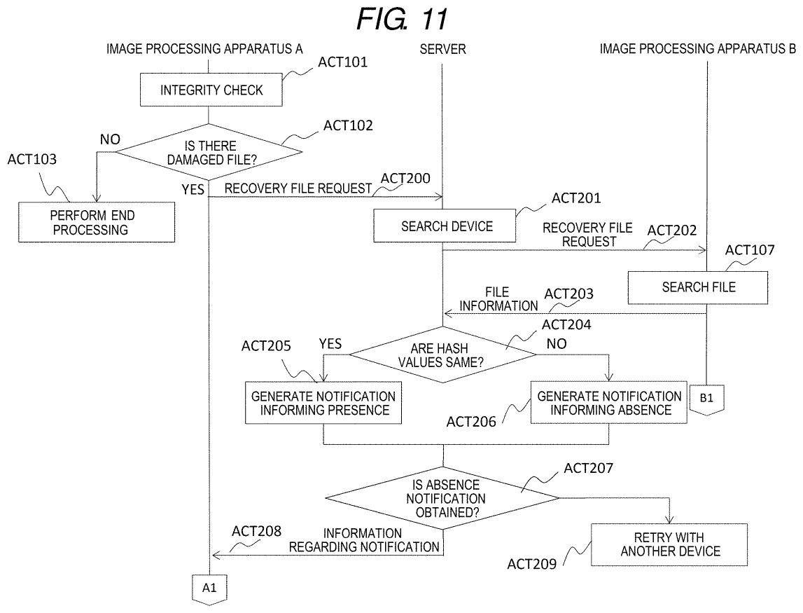

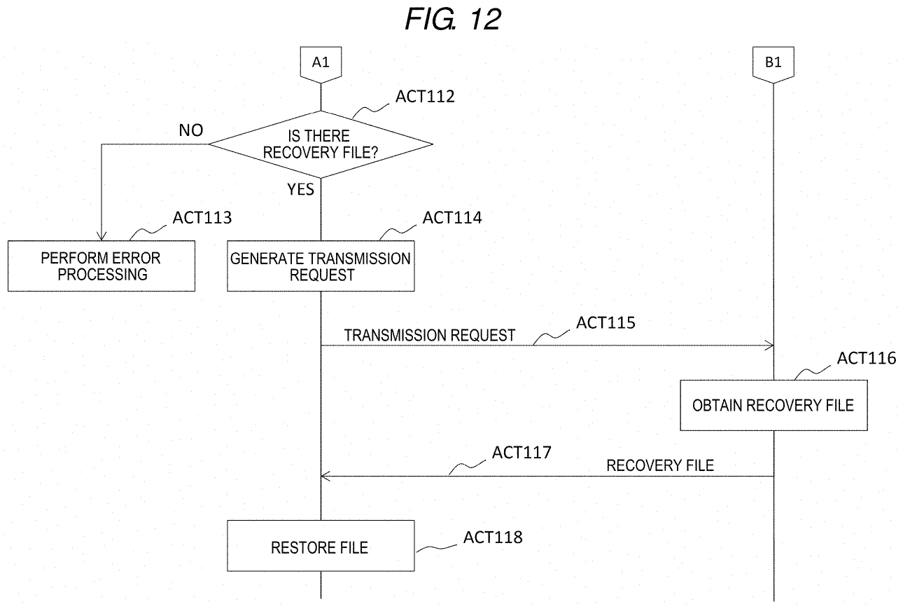

FIGS. 11 and 12 are sequence diagrams illustrating a flow of file restoration performed by the image processing system 400a of the second embodiment. In FIGS. 11 and 12, the same reference numerals are assigned to the same operations as those illustrated in FIGS. 6 and 7. In FIGS. 11 and 12, different reference numerals (ACT 200 series numbers) are assigned to operations which are not illustrated in FIGS. 6 and 7.

First, ACT 101 to ACT 103 are performed. When there is a damaged file (ACT 102—YES), the damaged file determiner 71 may obtain predetermined information. The predetermined information includes, for example, a hash value obtained when the damaged file was normal, a file name, and a path name. The response unit 73a generates a request for a recovery file based on the predetermined information. The request for the recovery file is information indicating a request to check the presence of the recovery file. The request for the recovery file includes a hash value, a file name, and a path name. The response unit 73a transmits the generated request for the recovery file to the server 300 (ACT 200).

When receiving the request for the recovery file, the response unit 73b of the server 300 searches for image processing apparatuses 100 other than the image processing apparatuses A transmitting the request (ACT 201). The searching is performed based on data stored in the address information storage unit 51. When none of the image processing apparatuses 100 store the recovery file, the response unit 73b transmits an error notification to the image processing apparatus A. In this case, the damaged file determiner 71 of the image processing apparatus A performs error processing. In detail, the damaged file determiner 71 notifies the control panel 120 about an error. In this case, the control panel 120 informs the user about the occurrence of the error.

When the image processing apparatus 100 storing the recovery file is searched for, the response unit 73b transmits information equivalent to the received request for the recovery file to the searched image processing apparatus 100 (ACT 202).

The response unit 73a of the image processing apparatus B receives the request for the recovery file. The response unit 73a searches for a file with the same name as the file name included in the received request for the recovery file (ACT 107). The response unit 73a calculates a hash value of the searched file. The response unit 73a generates file information including a path name and the hash value of the searched for file. Thereafter, the response unit 73a transmits the generated file information to the server 300.

The response unit 73b of the server 300 receives the file information. The hash value determiner 72 determines whether or not the hash value included in the received file information and the hash value included in the request for the recovery file are the same (ACT 204).

When the hash values are the same (ACT 204—YES), the response unit 73b generates a notification informing the presence of the recovery file (ACT 205). When the hash values are different (ACT 204—NO), the response unit 73b generates a notification informing the absence of the recovery file (ACT 206).

The response unit 73b determines whether or not the generated notification is a notification informing the absence of the recovery file (ACT 207). When the generated notification is the notification informing the absence of the recovery file, operations after ACT 106 are performed again with respect to another image processing apparatus 100 (ACT 209). In this case, the other image processing apparatus 100 is an apparatus which is determined to store the recovery file as a result of performing ACT 104 and to which the request for the recovery file is not transmitted.

Thereafter, the response unit 73b transmits the notification informing the presence or absence of the recovery file to the image processing apparatus A which transmitted the request for the recovery file (ACT 208).

Operations after ACT 208 (operations illustrated in FIG. 12) are the same as those after ACT 113 in the first embodiment. Accordingly, a description thereof is omitted here.

According to the image processing system 400a of the second embodiment configured as described above, a damaged file is restored without manual intervention. Thus, even if a damaged file is generated in the image processing apparatus 100, it is possible to reduce efforts and costs required to restore the damaged file.

Furthermore, according to the image processing system 400a of the second embodiment, the recovery file is obtained from another image processing apparatus 100 connected to the same image processing system 400a. Generally, a file of the same version is likely to be used in devices connected to the same image processing system 400a. Accordingly, there is a high possibility that a file of the same version as the damaged file before the damaged file was damaged will be searched for.

Furthermore, according to the image processing system 400a of the second embodiment, the server 300 searches for image processing apparatus 100 storing the recovery file. Thus, the image processing apparatus 100 storing the damaged file need not to be searched for other image processing apparatuses 100 and may request the server 300 to search for other image processing apparatuses 100. Accordingly, it is possible to reduce the load of processing performed by the image processing apparatus 100 and the burden of maintenance of address information.

### Modification Example

When a serious problem such as a booting failure due to damage to a kernel file occurs, the image processing apparatus 100 may stop an operation thereof. Furthermore, when an error occurs, the image processing apparatus 100 may notify a service center of the error by using a communication unit such as a mail or a facsimile function.

A work performed by the server 300 and a work performed by the image processing apparatus 100 may be distributed differently from those in the above-described embodiment. For example, after ACT 201, the server 300 may notify the image processing apparatus A of address information of the searched other image processing apparatus B. In this case, operations after ACT 106 of FIG. 6 may be performed by the image processing apparatuses A and B. For example, ACT 203 may not be performed and ACT 204 to ACT 208 may be performed by the image processing apparatus B. For example, in FIG. 12, ACT 116 may be performed by the server 300. In this case, the response unit 73b of the server 300 may transmit a transmission request to the image processing apparatus B upon receiving the transmission request. Thereafter, the response unit 73a of the image processing apparatus B may transmit the recovery file to the server 300, and the response unit 73b of the server 300 may transmit the recovery file to the image processing apparatus A.

In ACT 116 to ACT 118, the server 300 may be configured to mediate the transmission and reception of the recovery file. In this case, the response unit 73a of the image processing apparatus A transmits the transmission request to the server 300. When receiving the transmission request, the response unit 73b of the server 300 transmits the transmission request to the image processing apparatus B storing the requested recovery file. The image processing apparatus B performs an operation corresponding to ACT 117. Thereafter, the response unit 73a of the image processing apparatus B transmits the recovery file to the server 300 which transmitted the transmission request. The response unit 73b of the server 300 transmits the received recovery file to the image processing apparatus A which transmitted the transmission request. When receiving the recovery file from the server 300, the response unit 73a of the image processing apparatus A performs recovery corresponding to ACT 119.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An image processing apparatus, comprising:
a damaged file determiner configured to determine whether or not a file used in the image processing apparatus is damaged;
a response unit configured to request another image processing apparatus to provide a recovery file for restoring the damaged file and obtain the recovery file from the other image processing apparatus, when the file is damaged; and
a file restoration unit configured to restore the damaged file by using the recovery file.

2. The apparatus according to claim 1, further comprising a hash value determiner configured to compare a hash value obtained before the file is damaged with a hash value obtained from the recovery file, wherein
the response unit transmits the recovery file to the another image processing apparatus when the hash value obtained before the file is damaged and the hash value obtained from the recovery file are the same.

3. The apparatus according to claim 1, further comprising a hash value determiner configured to compare a hash value obtained before the file is damaged with a hash value obtained from the recovery file, wherein
the file restoration unit restores the damaged file by using the recovery file when the hash value obtained before the file is damaged and the hash value obtained from the recovery file are the same.

4. The apparatus according to claim 1, further comprising:
a path name determiner configured to compare a path name indicating a storage region storing the damaged file of the image processing apparatus with a path name indicating a storage region storing the recovery file, wherein
the response unit transmits the recovery file to another apparatus when the path name indicating the storage region storing the damaged file of the image processing apparatus and the path name indicating the storage region storing the recovery file are the same.

5. The apparatus according to claim 1, wherein
the response unit identifies another image processing apparatus storing the recovery file, requests to the identified another image processing apparatus to provide the recovery file, and receives the recovery file from the other image processing apparatus.

6. The apparatus according to claim 1, wherein
the response unit requests a predetermined server to provide the recovery file, and receives the recovery file from the other image processing apparatus.

7. The apparatus according to claim 1, wherein
the response unit requests a predetermined server to provide the recovery file, and receives the recovery file from the other image processing apparatus via the predetermined server.

8. The apparatus according to claim 7, wherein
the response unit transmits a hash value obtained before the file is damaged to the predetermined server, and receives the recovery file, which is determined by the predetermined server to have a hash value matching the obtained hash value, from the predetermined server.

9. The apparatus according to claim 1, wherein
the response unit requests a predetermined server to provide information regarding another image processing apparatus storing the recovery file, and requests the other image processing apparatus, which is indicated by a response result from the predetermined server, to provide the recovery file.

10. An image processing method comprising:
determining whether or not a file used in an image processing apparatus is damaged;
requesting another image processing apparatus to provide a recovery file to be used to restore the damaged file when the file is damaged;
obtaining the recovery file stored in another image processing apparatus; and
restoring the damaged file by using the recovery file.

11. The method according to claim 10, further comprising:
comparing a hash value obtained before the file is damaged with a hash value obtained from the recovery file; and
transmitting the recovery file to the another image processing apparatus when the hash value obtained before the file is damaged and the hash value obtained from the recovery file are the same.

12. The method according to claim 10, further comprising:
comparing a hash value obtained before the file is damaged with a hash value obtained from the recovery file; and
restoring the damaged file by using the recovery file when the hash value obtained before the file is damaged and the hash value obtained from the recovery file are the same.

13. The method according to claim 10, further comprising:
comparing a path name indicating a storage region storing the damaged file of the image processing apparatus with a path name indicating a storage region storing the recovery file; and
transmitting the recovery file to another apparatus when the path name indicating the storage region storing the damaged file of the image processing apparatus and the path name indicating the storage region storing the recovery file are the same.

14. The method according to claim 10, further comprising:
identifying another image processing apparatus storing the recovery file, requesting to the identified another image processing apparatus to provide the recovery file, and receiving the recovery file from the other image processing apparatus.

15. The method according to claim 10, further comprising:
requesting a predetermined server to provide the recovery file, and receiving the recovery file from the other image processing apparatus.

16. The method according to claim 10, further comprising:
requesting a predetermined server to provide the recovery file, and receiving the recovery file from the other image processing apparatus via the predetermined server.

17. The method according to claim 16, further comprising:
transmitting a hash value obtained before the file is damaged to the predetermined server, and receiving the recovery file, which is determined by the predetermined server to have a hash value matching the obtained hash value, from the predetermined server.

18. The method according to claim 10, further comprising:
requesting a predetermined server to provide information regarding another image processing apparatus storing the recovery file, and requesting the other image processing apparatus, which is indicated by a response result from the predetermined server, to provide the recovery file.

19. A data corruption remediating system, comprising:
a damaged file determiner configured to determine whether or not a file used in a first image processing apparatus is damaged;
a response unit, in the first image processing apparatus, configured to request a second image processing apparatus to provide a recovery file for restoring the damaged file and obtain the recovery file from the second image processing apparatus, when the file is damaged; and
a file restoration unit, in the first image processing apparatus, configured to restore the damaged file by using the recovery file.

20. The data corruption remediating system according to claim 19, further comprising:
a hash value determiner configured to compare a hash value obtained before the file is damaged with a hash value obtained from the recovery file, wherein either:
the response unit transmits the recovery file to the second image processing apparatus when the hash value obtained before the file is damaged and the hash value obtained from the recovery file are the same, or
the file restoration unit restores the damaged file by using the recovery file when the hash value obtained before the file is damaged and the hash value obtained from the recovery file are the same.
